(19) United States
(12) Patent Application Publication
(10) Pub. No.: US 2009/0224091 A1
(43) Pub. Date: Sep. 10, 2009

(54) Reel and recording tape cartridge

(75) Inventor: Ren Ishikawa, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/379,672

(22) Filed: Feb. 26, 2009

(30) Foreign Application Priority Data
Mar. 5, 2008 (JP) 2008-055042

(51) Int. Cl. G11B 23/107; B65H 75/18; G11B 23/04; B65H 75/14

(52) U.S. Cl. 242/348; 242/610.6

(57) ABSTRACT

A reel is disposed with a reel hub made of resin whose outer peripheral surface is configured as a tape take-up surface and a reinforcement ring that is integrated with the reel hub by insert molding. On a bottom plate of the reel hub, there are formed: marks of gates that are disposed on a radial direction inner side with respect to the reinforcement ring and are used for injecting, into a die, a resin material that molds the reel hub; and at least one of thick portions that are positioned on the reinforcement ring side with respect to the marks of the gates and thin portions that are positioned on both sides, in a circumferential direction of the reel hub, with respect to the marks of the gates.

### CROSS-REFERENCE TO RELATED APPLICATION

This application claims priority under 35 USC 119 from Japanese Patent Application No. 2008-055042, the disclosure of which is incorporated by reference herein.

### BACKGROUND OF THE INVENTION

1. Field of the Invention

The present invention relates to a reel for winding recording tape such as magnetic tape, for example, and to a recording tape cartridge disposed with this reel.

2. Description of the Related Art

There is known a technology where a circular cylinder-shaped metal insert portion is disposed in a hub that is made of resin and winds magnetic tape (e.g., see JP-A No. 2005-116163).

Incidentally, when the reel, into whose hub the metal insert portion is inserted, is formed by injection molding, there is the problem that it is easy for cracks running parallel to each other in the circumferential direction to form in the end surfaces of the hub because contraction in the circumferential direction of the hub is controlled by the metal insert portion, and this causes yield deterioration.

### SUMMARY OF THE INVENTION

In view of these circumstances, it is an object of the present invention to obtain a reel and a recording tape cartridge that can control the occurrence of cracks in the end surfaces of a reel hub that is made of resin.

A reel pertaining to a first aspect of the invention is disposed with a reel hub made of resin whose outer peripheral surface is configured as a take-up surface of an object-to-be-taken-up and a reinforcement ring that is integrated with the reel hub by insert molding, with reinforcement fiber being mixed into the reel hub or a portion made of resin formed integrally with the reel hub, the reel comprising: marks of gates for injecting, into a die, a resin material that molds the reel hub; and at least one of thick portions that are positioned on the reinforcement ring side with respect to the marks of the gates and thin portions that are positioned on both sides, in a circumferential direction of the reel hub, with respect to the marks of the gates.

In the reel of the first aspect of the invention, resin that has been injected from the gates is solidified inside the die in which the reinforcement ring has been set, whereby the reel hub with which the reinforcement ring has been integrated is formed. In this reel, the marks of the gates are disposed on a radial direction inner side or outer side, with respect to the reinforcement ring, of the reel hub or the portion made of resin formed integrally with the reel hub.

Around the gates, there is formed at least one of thick portions that promote the flow of the resin along the radial direction of the reel hub from the gates and thin portions that control the flow of the resin in the circumferential direction of the reel hub from the gates, so the flow of the resin at the time of molding flows mainly from the gates toward the reinforcement ring along the radial direction of the reel hub and thereafter flows in the circumferential direction along the reinforcement ring and the take-up surface. Thus, in the present reel, the reinforcement fiber in the resin is oriented along the circumferential direction of the reinforcement ring and the take-up surface. For this reason, in the present reel, the occurrence of cracks along the radial direction in the end surfaces of the reel hub is effectively controlled.

In this manner, in the reel of the first aspect of the present invention, the occurrence of cracks in the end surfaces of a reel hub made of resin can be controlled.

A reel pertaining to a second aspect of the invention is disposed with a reel hub made of resin whose outer peripheral surface is configured as a take-up surface of an object-to-be-taken-up and a reinforcement ring that is integrated with the reel hub by insert molding, with reinforcement fiber being mixed into the reel hub or a portion made of resin formed integrally with the reel hub, the reel comprising: a mark of gates for injecting, into a die, a resin material that molds the reel hub; and marks of a guide structure that is disposed between the marks of the gates and the reinforcement ring and is for guiding the flow of the resin from the gates toward the reinforcement ring at the time of molding of the reel hub.

In the reel of the second aspect of the invention, resin that has been injected from the gates is solidified inside the die in which the reinforcement ring has been set, whereby the reel hub with which the reinforcement ring has been integrated is formed. In this reel, the marks of the gates are disposed on a radial direction inner side or outer side, with respect to the reinforcement ring, of the reel hub or the portion made of resin formed integrally with the reel hub.

Around the gates, there are formed the marks of the guide structure, so the flow of the resin at the time of molding is guided by the guide structure, whereby the flow of the resin at the time of molding flows mainly from the gates toward the reinforcement ring along the radial direction of the reel hub and thereafter flows in the circumferential direction along the reinforcement ring and the take-up surface. Thus, in the present reel, the reinforcement fiber in the resin is oriented along the circumferential direction of the reinforcement ring and the take-up surface. For this reason, in the present reel, the occurrence of cracks along the radial direction in the end surfaces of the reel hub is effectively controlled.

In this manner, in the reel of the second aspect of the present invention, the occurrence of cracks in the end surfaces of a reel hub made of resin can be controlled.

In the reel of the second aspect of the invention, the marks of the guide structure may include at least one of thick portions that are positioned on the reinforcement ring side with respect to the marks of the gates and thin portions that are positioned on both sides, in a circumferential direction of the reel hub, with respect to the marks of the gates.

In the reel of this configuration, the thick portions contribute to guiding the flow of the resin in the direction along the radial direction of the reel hub from the gates because of the relatively large flow path cross-sectional area of the thick portions, and the thin portions contribute to controlling the flow of the resin in the circumferential direction of the reel hub from the gates because of the relatively small flow path cross-sectional area of the thin portions. Because of at least one of these, at the time of molding of the present reel, the flow of the resin is guided in the direction along the radial direction of the reel hub from the gates.

Further, a recording tape cartridge is provided by comprising: a case; and the reel of the first aspect or the second aspect of the invention, with recording tape being wound around the take-up surface of the reel hub and the reel being housed in the case such that the recording tape is capable of being pulled out and taken up.

In the recording tape cartridge configured as described above, the recording tape that is wound around the reel hub of the reel is pulled out from the case, and reading and writing (or either one) of information are performed. The occurrence of cracks in the end surfaces of the reel hub is controlled because the recording tape cartridge employs the reel of the first or second aspect as this reel.

In this manner, in the recording tape cartridge of this configuration, the occurrence of cracks in the end surfaces of a reel hub made of resin can be controlled.

As described above, the reel pertaining to the present invention has the excellent effect that it can control the occurrence of cracks in the end surfaces of a reel hub made of resin.

### BRIEF DESCRIPTION OF THE DRAWINGS

FIG. 1A and FIG. 1B are enlarged views showing relevant potions of a reel pertaining to an embodiment of the present invention, with FIG. 1A being a perspective view showing the reel as seen from above and FIG. 1B being a perspective view showing the reel as seen from below;

FIG. 2A is a bottom view schematically showing resin flow directions at the time of molding of the reel pertaining to the embodiment of the present invention, and FIG. 2B is a bottom view schematically showing resin flow directions at the time of molding of a reel pertaining to a comparative example;

FIG. 3 is an exploded perspective view showing a partial cutaway of the reel pertaining to the embodiment of the present invention as seen from below;

FIG. 4 is an exploded perspective view showing the reel pertaining to the embodiment of the present invention as seen from above;

FIG. 5 is a cross-sectional view of a reel hub that configures the reel pertaining to the embodiment of the present invention;

FIG. 6A and FIG. 6B are views showing the exterior of a recording tape cartridge to which the reel pertaining to the embodiment of the present invention is applied, with FIG. 6A being a perspective view showing the recording tape cartridge as seen from above and FIG. 6B being a perspective view showing the recording tape cartridge as seen from below;

FIG. 7 is a cross-sectional view, at a time when rotation of the reel is locked, of the recording tape cartridge to which the reel pertaining to the embodiment of the present invention is applied;

FIG. 8 is a cross-sectional view, at a time when rotation of the reel is unlocked, of the recording tape cartridge to which the reel pertaining to the embodiment of the present invention is applied;

FIG. 9 is a cross-sectional view showing a process of injection-molding the reel hub that configures the reel pertaining to the embodiment of the present invention;

FIG. 10 is a bottom view schematically showing resin flow directions at the time of molding of a reel pertaining to a modification of the embodiment of the present invention; and

FIG. 11A and FIG. 11B are enlarged views showing relevant portions of the reel pertaining to the comparative example of the embodiment of the present invention, with FIG. 11A being a perspective view showing the reel as seen from above and FIG. 11B being a perspective view showing the reel as seen from below.

### DETAILED DESCRIPTION OF THE INVENTION

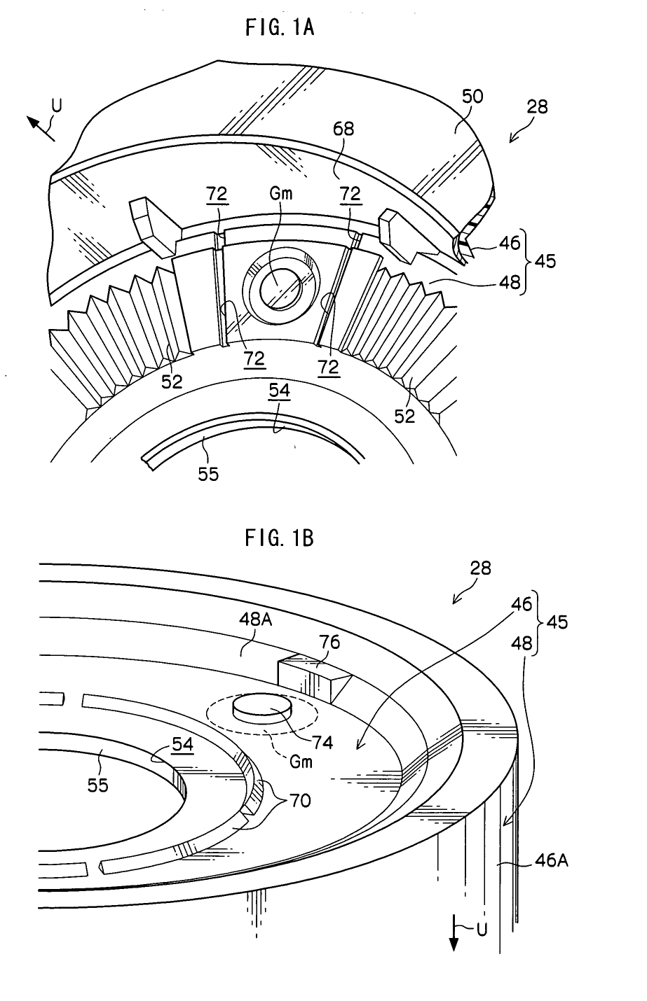

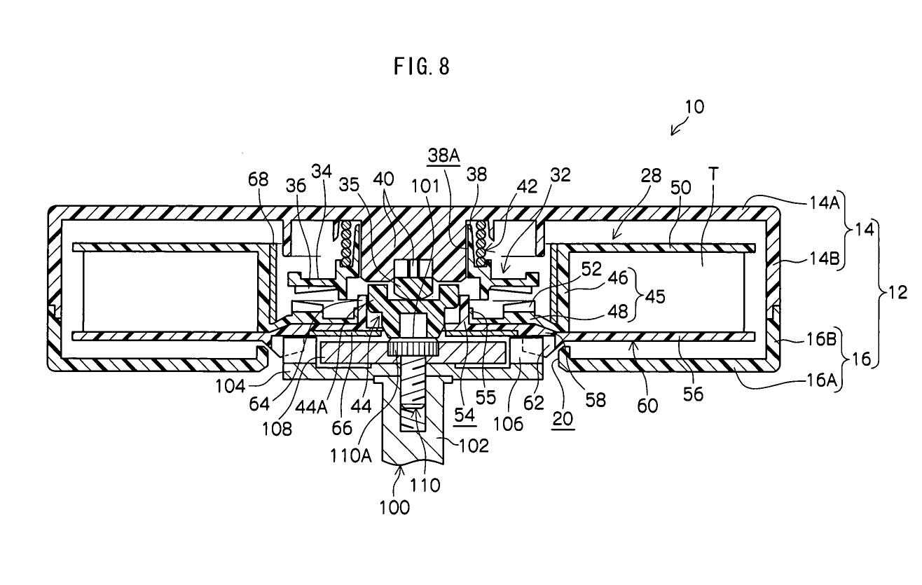

A reel 28 pertaining to an embodiment of the present invention and a recording tape cartridge 10 to which the reel 28 is applied will be described on the basis of FIG. 1A to FIG. 9. First, the general overall configuration of the recording tape cartridge 10 will be described, next the configuration of the reel 28 will be described, and thereafter the configuration of gate mark portions, which are relevant portions of the present invention, will be described in detail.

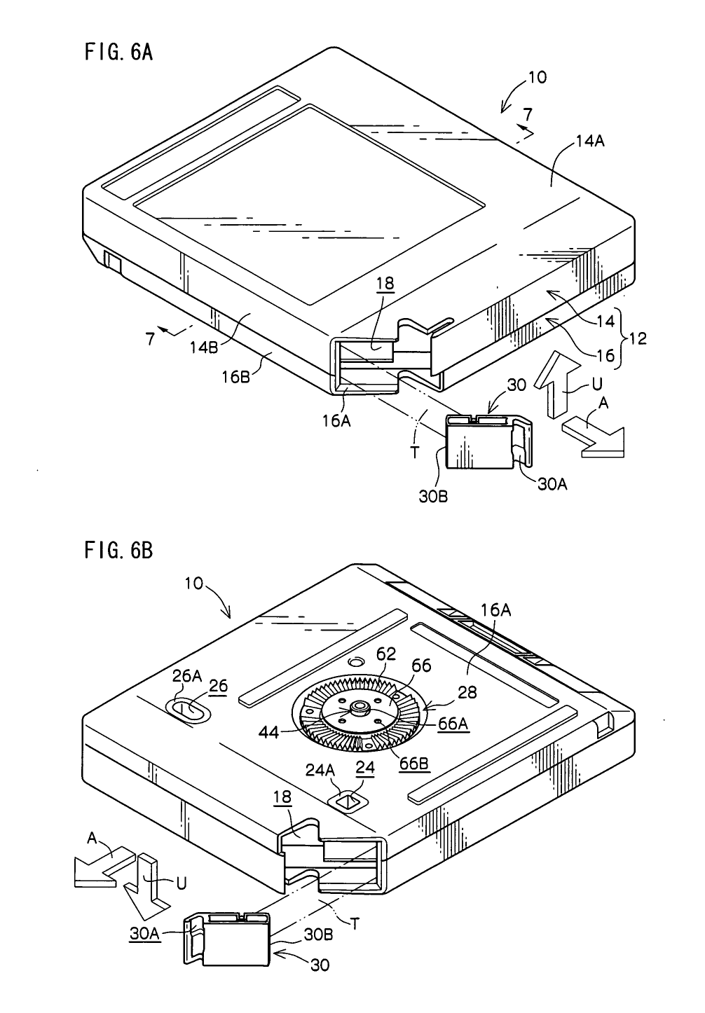

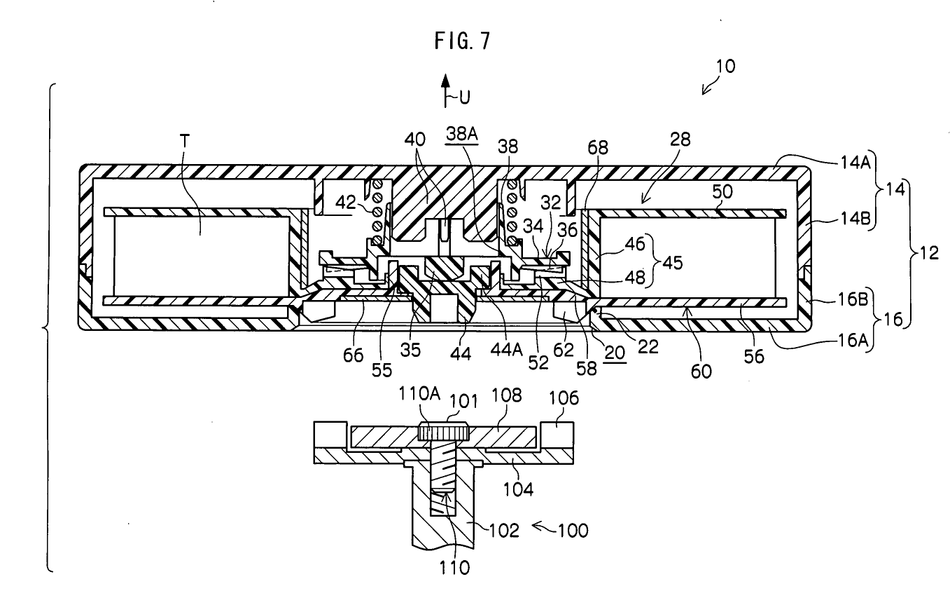

In FIG. 6A, there is shown a perspective view where the recording tape cartridge 10 is seen diagonally from above, and in FIG. 6B, there is shown a perspective view where the recording tape cartridge 10 is seen diagonally from below. Further, in FIG. 7, there is shown a cross-sectional view along line 7-7 of FIG. 6A. It will be noted that arrow A shown in FIG. 6A and FIG. 6B represents the direction in which the recording tape cartridge 10 is loaded into a drive device, and in the following description, the side represented by arrow A will be referred to as a front side for the sake of convenience. Further, the side represented by arrow U will be referred to as an upper side.

As shown in these drawings, the recording tape cartridge 10 is disposed with a case 12. The case 12 is configured by joining together an upper case 14 and a lower case 16. Specifically, the upper case 14 is configured as a result of a substantially frame-like peripheral wall 14B being disposed upright along the outer edge of a top plate 14A that has substantially rectangular shape when seen in a planar view, and the lower case 16 is configured as a result of a substantially frame-like peripheral wall 16B being disposed upright along the outer edge of a bottom plate 16A that has a shape substantially corresponding to that of the top plate 14A. Additionally, the case 12 is formed in a substantially box-like shape when the upper case 14 and the lower case 16 are joined together by ultrasonic welding or with screws in a state where the open end of the peripheral wall 14B and the open end of the peripheral wall 16B have been brought into contact with each other.

An opening 18 that slants with respect to the loading direction is formed in the case 12 by cutting out corner portions of the top plate 14A, the peripheral wall 14B, the bottom plate 16A and the peripheral wall 16B on the leading side in the direction in which the recording tape cartridge 10 is loaded into the drive device. Further, a circular gear opening 20 that penetrates the bottom plate 16A is disposed in the substantial center portion of the bottom plate 16A and serves to expose a later-described reel gear 62. An annular rib 22 is disposed on the edge portion of the gear opening 20 in the bottom plate 16A so as to project inside the case 12 (see FIG. 7) and serves to position the later-described reel 28.

A pair of positioning holes 24 and 26 are formed in the outer surface of the bottom plate 16A in the vicinity of the front end of the case 12. The pair of positioning holes 24 and 26 are disposed sac-like inside projecting portions (not shown) disposed upright inside the case 12 from the bottom plate 16A and are arranged apart from each other on a hypothetical line orthogonal to the loading direction. The positioning hole 24 near the opening 28 has a substantially square shape when seen in a bottom view that circumscribes a positioning pin of the drive device, and the positioning hole 26 is an elongate hole that is long along the hypothetical line and has a width corresponding to the diameter of a positioning pin. Thus, when the recording tape cartridge 10 is loaded into the drive device and the positioning pins are respectively inserted into the positioning holes 24 and 26, the recording tape cartridge 10 is accurately positioned in the horizontal direction (left and right, front and back) inside the drive device.

Moreover, the portions of the bottom plate 16A around the positioning holes 24 and 26 serve as positioning surfaces 24A and 26A that are finished more smoothly than the other portion (design surface) of the bottom plate 16A. The positioning surfaces 24A and 26A are configured to contact positioning surfaces of the drive device disposed around the positioning pins when the positioning pins are inserted into the positioning holes 24 and 26. Thus, the recording tape cartridge 10 is also positioned in the vertical direction inside the drive device.

As shown in FIG. 7, the reel 28, which will be described in detail later, is rotatably housed inside the case 12 that has been described above. Just one reel 28 is disposed. Magnetic tape T that serves as recording tape is wound onto the reel 28, and a leader block 30 that serves as a pullout member is attached to the leading end of the magnetic tape T.

The leader block 30 is configured to be housed and held inside the opening 28 in the case 12 when the recording tape cartridge 10 is not in use. In this state, the leader block 30 closes off the opening 18 and deters the ingression of dust or the like into the inside of case 12. Further, an engagement concave portion 30A is formed in the leading end of the leader block 30, so that when the magnetic tape T is to be pulled out inside the drive device, the leader block 30 is pulled out from the case 12 by pullout means engaging with the engagement concave portion 30A and is guided to a take-up reel of the drive device. Moreover, the end surface of the leader block 30 on the opposite side of the engagement concave portion 30A serves as a circular arc surface 30B and is fitted into the take-up reel to configure part of a take-up surface that takes up the magnetic tape T.

Further, the recording tape cartridge 10 is disposed with a brake member 32 for deterring rotation of the reel 28 when the recording tape cartridge 10 is not in use. The brake member 32 has, as its main portions, a disc portion 34 that is formed in a disc shape, a brake gear 36 that is formed face down on the peripheral edge portion of the disc portion 34, a cross-shaped projection 38 that is disposed so as to project upward from the axial center portion of the disc portion 34, and a slide-contact projecting portion 35 disposed so as to project downward from the axial center portion of the disc portion 34. An insertion groove 38A formed in a substantial cross shape when seen in a planar view is formed in the cross-shaped projection 38 in correspondence to the shape of the cross-shaped projection 38, and a cross-shaped rib 40 disposed face down from the top plate 14A is inserted into the insertion groove 38A so as to be capable of relative movement (sliding motion) in the up and down direction. Thus, the brake member 32 is configured to be incapable of rotation with respect to the case 12 and capable of relative displacement in the up and down direction.

The brake gear 36 of the brake member 32 meshes with an engagement gear 52 disposed in a bottom plate 48 configuring the reel 28 (these will be described later) to thereby prevent rotation of the reel 28 with respect to the case 12, and the brake member 32 moves in the up and down direction (axial line direction of the reel 28) with respect to the case 12 to thereby switch between a state where the brake gear 36 meshes with the engagement gear 52 and a state where the brake gear 36 disengages from the engagement gear 52. A compression coil spring 42 that energizes the brake member 32 toward the bottom plate 48 is disposed in the recording tape cartridge 10, and ordinarily the brake gear 36 of the brake member 32 is biased in a brake position where it is meshed with the engagement gear 52.

Further, the recording tape cartridge 10 is disposed with a clutch member 44 that penetrates the axial center portion of the bottom plate 48 of the reel 28 and is supported so as to be capable of coaxial and integral rotation with the reel 28, capable of relative displacement in the axial line direction with respect to the reel 28, and incapable of falling out. The clutch member 44 is pressed by the slide-contact projecting portion 35 of the brake member 32 whose brake gear 36 is meshed with the engagement gear 52, so that part of the clutch member 44 projects outside (below) the reel 28. The brake member 32 is configured such that, when the slide-contact projecting portion 35 is pressed upward, the brake member 32 moves upward and reaches a release position where the meshing between the brake gear 36 and the engagement gear 52 is released.

In this embodiment, the clutch member 44 is configured to be pressed upward by a release surface 101 disposed in the axial center portion of a rotating shaft 100 of the drive device to thereby cause the brake member 32 to move from the brake position to the release position.

To add more in regard to the rotating shaft 100, the rotating shaft 100 includes a rotating table 104 fixed to the upper end of a rotating axle 102, and a drive gear 106 capable of meshing with the reel gear 62 (described later) of the reel 28 is formed facing upward on the peripheral edge portion of the rotating table 104. Thus, the rotating shaft 100 is configured to move relatively upward with respect to the case 12 to thereby cause the drive gear 106 to mesh with the reel gear 62. Further, a disc-shaped magnet 108 is disposed on the radial direction inner side of the drive gear 106 on the rotating table 104, and the magnet 108 is fixed by a tap bolt 110 that penetrates the axial center portion of the magnet 108 and is screwed into the rotating axle 102. The aforementioned release surface 101 is configured by a head portion 110A of the tap bolt 110.

The recording tape cartridge 10 that has been described above is configured such that, during rotation of the reel 28 (when the magnetic tape T is being pulled out or taken up), relative rotation occurs between the slide-contact projecting portion 35 (the brake member 32) that does not rotate with respect to the case 12 and the clutch member 44 that rotates together with the reel 28, and the distal end (lower end) of the slide-contact projecting portion 35 and the upper surface of the clutch member 44 slide against each other because of this relative rotation.

### (Configuration of Reel)

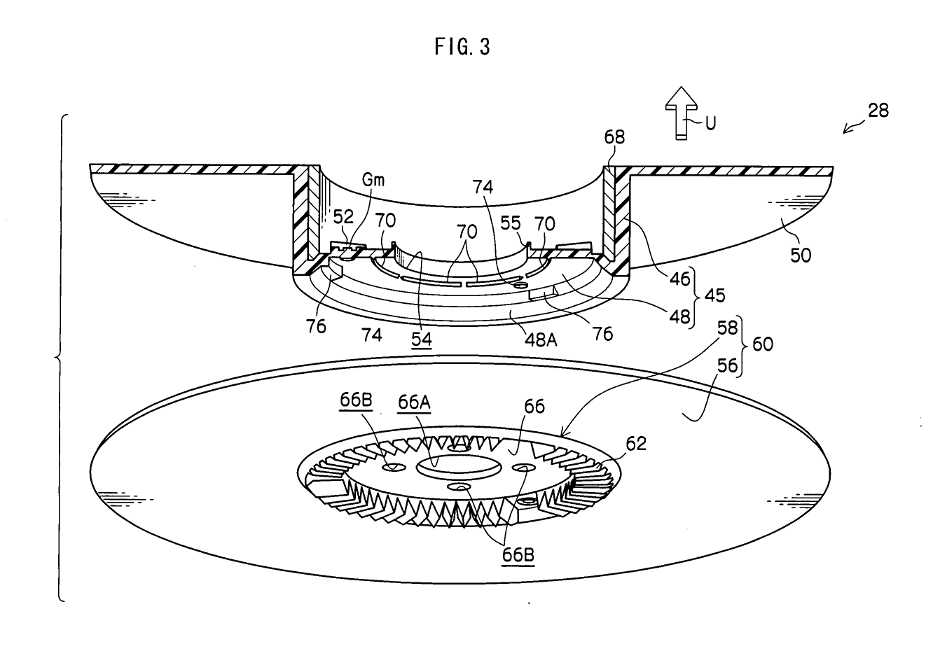

As shown in FIG. 3 to FIG. 5, the reel 28 is disposed with a reel hub 45 that configures the axial center portion of the reel 28. The reel hub 45 is formed in a substantially bottomed circular cylinder shape including a circular cylinder wall 46 whose outer peripheral surface serves as a tape take-up surface 46A for winding the magnetic tape T and a bottom plate 48 that closes off the lower portion of the circular cylinder wall 46. An upper flange 50 is disposed so as to extend coaxially and integrally outward in the radial direction from the upper end of the circular cylinder wall 46 of the reel hub 45.

Further, the engagement gear 52 capable of meshing with the brake gear 36 of the brake member 32 is formed facing upward on the bottom plate 48 of the reel hub 45. That is, as described above, the engagement gear 52 is configured to mesh with the brake gear 36 of the brake member 32 positioned in the brake position and, when the meshing between the engagement gear 52 and the brake gear 36 of the brake member 32 positioned in the release position is released, to allow rotation about the axis of the reel 28. In this embodiment, the engagement gear 52 is formed such that its teeth are arranged annularly when seen in a planar view.

Moreover, a through hole 54 that penetrates the bottom plate 48 in its plate thickness direction is formed in the axial center portion of the bottom plate 48 of the reel hub 45 and is configured to be able to allow part of the clutch member 44 to project therefrom. A short circular cylinder portion 55 that serves as a cylindrical portion is disposed facing upward upright from the peripheral edge portion of the through hole 54 in the bottom plate 48. The short circular cylinder portion 55 is formed integrally with the reel hub 45 and may be understood to have a turn-back shape with respect to the circular cylinder wall 46.

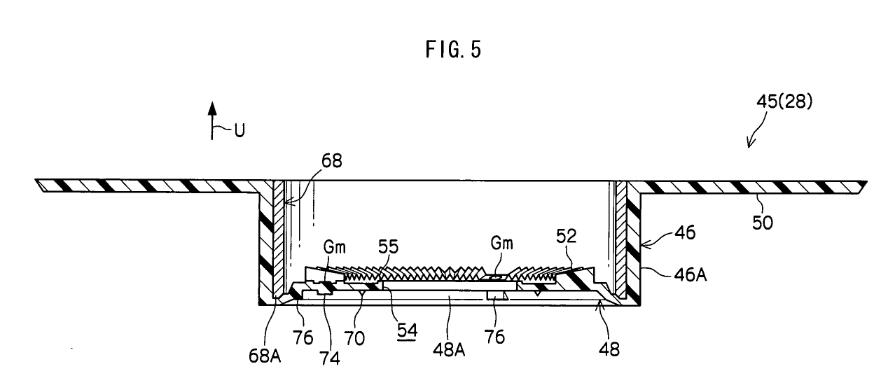

Excluding a reinforcement ring 68 that will be described later, each portion of the reel hub 45 described above, whose main portions are the circular cylinder wall 46, the bottom plate 48, the engagement gear 52 and the short circular cylinder portion 55, is formed integrally by resin molding as shown in FIG. 5.

Further still, as shown in FIG. 3 to FIG. 5, the reel 28 includes a lower flange 56 that faces the upper flange 50. The lower flange 56 is disposed so as to extend integrally outward in the radial direction from a center portion 58 that is joined together (this joined structure will be described later) with the bottom plate 48 of the reel hub 45, and the lower flange 56 is fixedly held to the reel hub 45 via this center portion 58. A lower flange member 60 that serves as a flange member is configured by the lower flange 56 and the center portion 58.

The reel gear 62 capable of meshing with the drive gear 106 of the rotating shaft 100 of the drive device is formed facing downward on the center portion 58 of the lower flange member 60. The reel gear 62 is configured overall such that its plural teeth are arrayed so as to form an annular shape that is coaxial with the lower flange member 60, that is, the reel 28. It will be noted that the reel gear 62 may also be configured to include regions where teeth are not formed in part of its circumferential direction.

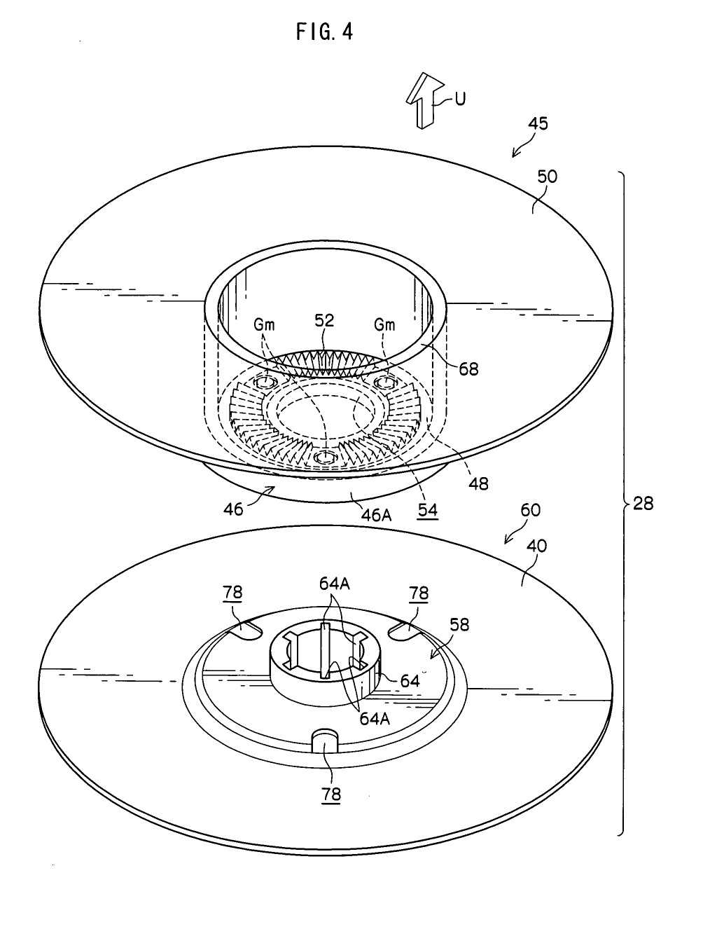

Further, as shown in FIG. 4 and FIG. 5, a clutch-use boss portion 64 for supporting the clutch member 44 is disposed facing upward upright from the axial center portion of the center portion 58. The clutch-use boss portion 64 is formed in a circular cylinder shape, is configured such that slits 64A that allow plural engagement pieces 44A projecting radially from the upper portion of the clutch member 44 to enter are formed in its cylinder wall, and supports the clutch member 44 such that the clutch member 44 is capable of sliding in its axial line direction and is incapable of relative rotation and incapable of falling out at each slide position. The clutch-use boss portion 64 is configured such that its outer diameter substantially coincides with the inner diameter of the through hole 54, that is, the short circular cylinder portion 55, and to fit together with the short circular cylinder portion 55.

Each portion of the lower flange member 60 described above, whose main portions are the lower flange 56, the center portion 58, the reel gear 62 and the clutch-use boss portion 64, is formed integrally by resin molding.

Moreover, as shown in FIG. 3 to FIG. 5, a reel plate 66 that serves as a metal plate comprising a magnetic body is fixedly disposed on the center portion 58. The reel plate 66 is formed in a substantial disc shape having a clear hole 66A in its axial center portion and is disposed coaxially on the radial direction inner side of the reel gear 62. The reel plate 66 is configured to be attracted by magnetic force to, but without contacting, the rotating table 104 of the rotating shaft 100 of the drive device.

The reel plate 66 is fixed to the center portion 58, that is, the lower flange member 60, by insert molding. Specifically, plural (in the present embodiment, four) small holes 66B disposed at equidistant intervals in the circumferential direction along a hypothetical circle coaxial with the clear hole 66A are formed in the reel plate 66 so as to penetrate the reel plate 66 in its plate thickness direction, and the portions of the small holes 66B on the underside of the reel plate 66 serve as an enlarged diameter portion to configure a so-called pillbox shape. The reel plate 66 is strongly fixed to the lower flange member 60 as a result of a resin material that has been injected into dies and has filled each of the small holes 66B cooling and solidifying. It will be noted that the reel plate 66 may also have a structure where it is fixed to the lower flange member 60 by caulking or the like.

In the reel 28 that has been described above, the lower flange member 60 is, as described above, joined together with the bottom plate 48 of the reel hub 45 at the lower flange 56. Specifically, in this embodiment, as shown in FIG. 3, welding-use projections (energy directors) 70 are disposed so as to project from the undersurface of the bottom plate 48, and ultrasonic oscillation is applied in a state where the welding-use projections 70 have been brought into contact with the upper surface of the center portion 58, whereby the reel hub 45 and the lower flange member 60 are ultrasonically welded together at the installation portions of the welding-use projections 70.

From this drawing, it will be understood that the reel hub 45 and the lower flange member 60 are joined together inside the installation region of the reel plate 66. More specifically, the welding-use projections 70, that is, the welding sites, are, as shown in FIG. 3, disposed so as to project intermittently along a hypothetical circle that is coaxial with the reel 28. This hypothetical circle is, as shown in FIG. 5, configured to have a smaller diameter than the inner edges of the engagement gear 52 and the reel gear 62 and a larger diameter than the diameter of a hypothetical circle that the outer diameter of the clutch-use boss portion 64 and the welding-use projections 70 inscribe.

Further, in this embodiment, the reel 28 is disposed with a reinforcement ring 68 that is integrated by insert molding with the circular cylinder wall 46 of the reel hub 45. The reinforcement ring 68 is made of metal and is configured to have a structure that controls deformation of the circular cylinder wall 46, whose upper end is open, in the direction in which the circular cylinder wall 46 collapses inward the radial direction by the winding pressure of the magnetic tape T. The reinforcement ring 68 is configured by a drawn material such as aluminium or an aluminium alloy, for example. In this embodiment, the reinforcement ring 48 comprises aluminium or an aluminium alloy and has a thickness along its radial direction of substantially 1.0 mm. More specifically, the reinforcement ring 68 is configured by an aluminium material that has a proof stress of 350 [N/mm²]. This proof stress is set such that the deformation amount of the tape take-up surface 46A with respect to the winding constriction (winding pressure) of the magnetic tape T that is wound around the tape take-up surface 46A of the reel hub 45 becomes equal to or less than an allowable amount (such that settling does not arise).

The reel hub 45 is configured by polycarbonate (PC). The thickness of a portion 34A on the radial direction outer side, with respect to the reinforcement ring 68, of the circular cylinder wall 46 of the reel hub 45 is set to be in the range of 1.0 mm to 1.5 mm. In this embodiment, the thickness is set to be substantially 1.5 mm. In this embodiment, the reel hub 45 and the upper flange 50 are configured by polycarbonate into which glass fiber that serves as reinforcement fiber has been mixed at 10% by mass.

It will be noted that the reinforcement ring 68, which is to be understood as a reinforcement (stiffening) member for improving the radial direction rigidity of the circular cylinder wall 46 of the reel 45, is not limited to a dimension (thickness) and material (physical property) as long as it satisfies this function. Consequently, for example, a steel material, or a non-metal material such as resin or fiber-reinforced resin, can be used as the reinforcement ring 68. It will be noted that, in this embodiment, a corrosion control treatment such as plating, for example, is administered to the surface of the reinforcement ring 68 because aluminium is corrosive.

### (Configuration of Gate Mark Portions)

As shown in FIG. 4 and FIG. 5, gate marks Gm, which are marks of gates Gt (injection openings) for injecting a resin material into dies when the reel hub 45 is injection-molded, are formed on the bottom plate 48 of the reel hub 45. In this embodiment, the gate marks Gm are plurally (three) formed between the teeth of the engagement gear 52 on the bottom plate 48. In other words, in the reel 28, the engagement gear 52 is divided into three (three equal portions) in the circumferential direction by the three gate marks Gm. Consequently, the reel hub 45 is configured to be molded as a result of the resin material being injected from the upper surface side of the bottom plate 48 on the radial direction inner side with respect to the circular cylinder wall 46 and the reinforcement ring 68.

As shown in the enlarged view of the gate marks Gm in FIG. 1A, groove portions 72 that open upward are formed along the radial direction of the reel hub 45 on both circumferential direction sides of the gate marks Gm. The radial direction inner ends of the groove portions 72 are positioned further inward in the radial direction than a hypothetical circle that inscribes the three gate marks Gm, and the radial direction outer ends of the groove portions 72 are positioned close to the reinforcement ring 68 on the radial direction outer side of the hypothetical circle that inscribes the three gate marks Gm. The sites where these groove portions 72 are formed correspond to thin portions in the present invention.

Further, as shown in FIG. 3 and FIG. 5, convex portions 74 are formed on the back surfaces of the gate marks Gm on the bottom plate 48. The convex portions 74 are formed in a circular shape that is substantially concentric with the gate marks Gm when seen in a bottom view and are configured as marks of recesses of a die for ensuring the fluidity of the resin at the time of injection molding of the reel hub 45. It will be noted that, in response to the dimensional shape of the reel hub 45 (the thickness of the bottom plate 48, etc.), the reel 28 may also be given a configuration where the convex portions 74 are not disposed.

Additionally, as shown in FIG. 1B, which shows the reel hub 45 as seen from its back surface (undersurface) side, in this embodiment, convex portions 76 are formed on the radial direction outer side of the convex portions 74, that is, the gate marks Gm. The convex portions 76 are formed in substantially triangular shapes (each by itself has a substantially triangular cross section) when seen in a side view such that the convex portions 76 project downward and inward in the radial direction from a tapered portion 48A whose diameter gradually becomes larger downward at the peripheral edge portion of the bottom plate 48, and the convex portions 76 configure thick portions of the bottom plate 48, that is, thick portions in the present invention.

As shown in FIG. 3 and FIG. 5, the convex portions 76 are positioned between the reinforcement ring 68, whose lower end 68A is embedded between the circular cylinder wall 46 and the tapered portion 48A of the bottom plate 48, and the gate marks Gm, which are positioned close to the tapered portion 48A, in the radial direction of the reel hub 45.

Further, in the reel 28 pertaining to this embodiment, the convex portions 76 are configured to function as rotation stoppers when the reel hub 45 and the lower flange member 60 are joined together. That is, as shown in FIG. 4, three concave portions 78 are formed in the center portion 58 of the lower flange member 60 in correspondence to the three convex portions 76, and the convex portions 76 are fitted inside the concave portions 78, whereby the circumferential direction position of the lower flange member 60 is determined with respect to the reel hub 45 before ultrasonic welding. It will be noted that the concave portions 78 are configured so as to allow the corresponding convex portions 76 and the corresponding convex portions 74 to be fitted inside.

As described above, the reel hub 45, where the groove portions 72 and the convex portions 76 are formed around the gate marks Gm, is configured such that, at the time of injection molding, the flow of the resin in the circumferential direction is controlled by the groove portions 72 that serve as thin portions and such that the flow of the resin outward in the radial direction (toward the reinforcement ring 68 and the circular cylinder wall 46) is promoted by the convex portions 76 that serve as thick portions. At least one of the groove portions 72 and the convex portions 76 corresponds to marks of a guide structure in the present invention.

Next, the action of the present embodiment will be described.

When the recording tape cartridge 10 of the above-described configuration is not in use, the brake member 32 is positioned in a rotation lock position and the brake gear 36 is caused to mesh with the engagement gear 52 by the energizing force of the compression coil spring 42. For this reason, rotation of the reel 28 with respect to the case 12 is deterred. At this time, the reel gear 62 of the reel 28 is exposed from the gear opening 20, and the lower portion of the clutch member 44 projects from the clutch-use boss portion 64 and is exposed at the gear opening 20.

When the magnetic tape T is to be used, the recording tape cartridge 10 is loaded into a bucket (not shown) of the drive device along the direction of arrow A. Then, when the recording tape cartridge 10 is loaded a predetermined depth into the bucket, the bucket moves downward so that the rotating shaft 100 of the drive device relatively approaches (moves upward toward) the gear opening 20 in the case 12 and holds the reel 28. Specifically, the rotating shaft 100 attracts and holds, but does not contact, the reel plate 66 with the magnet 108 and causes the drive gear 106 to mesh with the reel gear 62.

In accompaniment with the drive gear 106 meshing with the reel gear 62, that is, the relative movement of the rotating shaft 100 in its axial direction toward the case 12, the rotating shaft 100 presses up the clutch member 44 that it is contacting at its release surface 101. Then, because of this pressing force, the clutch member 44 is guided in the slits 64A of the clutch-use boss portion 64 at its plural engagement pieces 44A and moves upward in the axial line direction of the reel 28 counter to the energizing force of the compression coil spring 42.

Thus, the brake member 32 contacting the upper surface of the clutch member 44 at its slide-contacting projection portion 35 also moves upward, and the meshing between the brake gear 36 of the brake member 32 and the engagement gear 52 is released. That is, the brake member 32 reaches a relative rotation allowance position with respect to the reel 28. When the rotating shaft 100 further relatively moves upward, the reel 28 is lifted upward (without its relative position being caused to change) together with the clutch member 44 and the brake member 32 counter to the energizing force of the compression coil spring 42, the brake member 32 reaches an absolute (with respect to the case 12) rotation allowance position, and the lower flange 52 separates from the annular rib 22. Due to the above, the reel 28 rises inside the case 12 and becomes rotatable without contacting the inner surface of the case 12.

Further, due to the lowering of the bucket, that is, the recording tape cartridge 10 inside the drive device, the positioning pins of the drive device respectively enter the positioning holes 24 and 26 in the case 12, and the positioning surfaces of the drive device come into contact with the positioning surfaces 24A and 26A of the case 12. Thus, the recording tape cartridge 10 is positioned in the horizontal direction and in the vertical direction with respect to the drive device. Then, the pullout means of the drive device causes its pullout pin (not shown) to engage with the engagement concave portion 30A of the leader block 30, pull out the leader block 30 from the case 12, and guide the leader block 30 to the take-up reel of the drive device. Moreover, the leader block 30 is fitted into the take-up reel to configure part of the take-up surface that takes up the magnetic tape T.

In this state, when the leader block 30 rotates integrally with the take-up reel, the magnetic tape T is pulled out from the case 12 through the opening 18 while being taken up onto a reel hub of the take-up reel. At this time, the reel 28 of the recording tape cartridge 10 rotates synchronously with the take-up reel by the rotational force of the rotating shaft 100 that is transmitted by the drive gear 106 meshing with the reel gear 62. Then, a recording and reproducing head disposed along a predetermined tape path of the drive device records information to the magnetic tape T or reproduces information that has been recorded on the magnetic tape T. At this time, the slide-contact projecting portion 35 of the brake member 32 that is incapable of rotation with respect to the case 12 slidingly contacts the upper surface of the clutch member 44 that rotates with respect to the case 12 together with the reel 28.

When the magnetic tape T is to be rewound onto the reel 28 and the leader block 30 is to be held in the vicinity of the opening 18 in the case 12, the bucket into which the recording tape cartridge 10 has been loaded is raised. Then, the meshing between the reel gear 62 and the drive gear 106 is released, the contact between the release surface 101 and the clutch member 44 is released, and the clutch member 44 moves downward together with the brake member 32 by the energizing force of the compression coil spring 42. Thus, the brake member 32 returns to the brake position where the brake gear 36 meshes with the engagement gear 52. Further, in accompaniment with operation where the brake member 32 and the clutch member 44 move by the energizing force of the compression coil spring 42, the reel 28 also moves downward and returns to its initial state where the lower flange 56 is brought into contact with the annular rib 22 and the reel gear 62 is exposed from the gear opening 20. In this state, the recording tape cartridge 10 is ejected from the bucket.

In manufacturing the reel 28 that configures this recording tape cartridge 10, first, the reel hub 45 and the lower flange member 60 are separately formed by injection molding. The reinforcement ring 68 is integrated with the reel hub 45 by insert molding, and the reel plate 66 is integrated with the lower flange member 60 by insert molding. Next, the clutch-use boss portion 64 of the lower flange member 60 is fitted together with the short circular cylinder portion 55 of the reel hub 45, the corresponding convex portions 76 and convex portions 74 are fitted inside the concave portions 78, and the lower flange member 60 is centered (positioned) with respect to the reel hub 45.

Then, ultrasonic vibration is generated from an ultrasonic horn in a state where the bottom plate 48, the center portion 58 and the reel plate 66 are sandwiched between a receiver (not shown), which contacts the reel plate 66 in a region (between the reel gear 62 and the small holes 66B) including the back surface portion of the site where the center portion 58 contacts the welding-use projections 70, and the ultrasonic horn, which contacts the back surfaces (between the engagement gear 52 and the short circular cylinder portion 55 at the upper surface) of the welding-use projections 70 of the bottom plate 48, and the reel hub 45 and the lower flange member 60 are ultrasonically welded together. Thus, the reel 28, where the reel hub 45 and the lower flange member 60 are fixed and where the magnetic tape T that is wound around the tape take-up surface 46A is protected by the upper flange 50 and the lower flange 56, is configured.

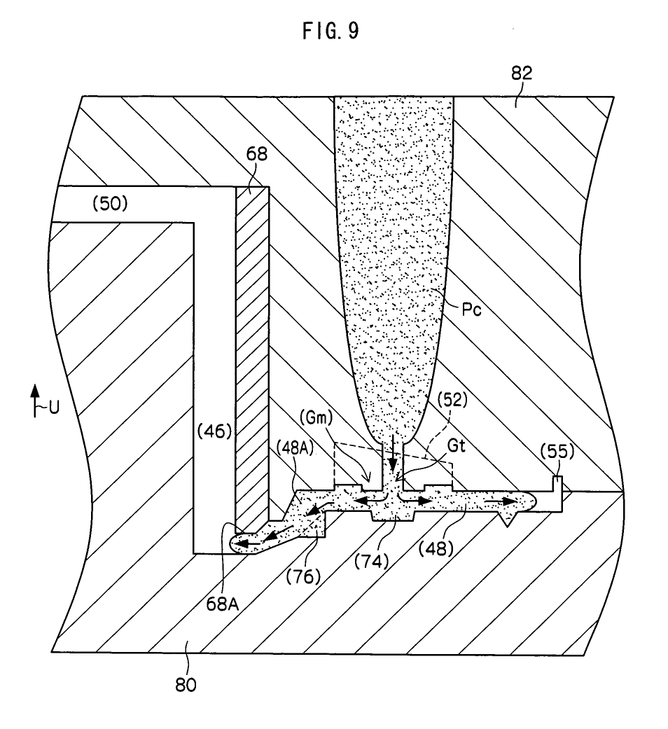

To add more in regard to injection molding of the reel hub 45, as shown in FIG. 9, the reinforcement ring 68 is set inside a space (cavity) formed by molding-use dies 80 and 82, polycarbonate PC into which glass fiber has been mixed (below, sometimes simply called “the polycarbonate PC”) is injected from the gates Gt. This polycarbonate PC flows inside the cavity as indicated by the arrows in FIG. 9 and fills the inside of the cavity (not shown). Thereafter, the polycarbonate PC is cooled and allowed to solidify, and the reel hub 45 that has been molded is removed from the molding-use dies 80 and 82.

Incidentally, in the reel hub 45 where the reinforcement ring 68 made of metal has been insert-molded, contraction that accompanies the above-described cooling and solidification of the circular cylinder wall 46 that is a resin molded portion is controlled by the reinforcement ring 68. In this embodiment, the coefficient of thermal expansion of the reinforcement ring 68 is 23 ppm with respect to 55 ppm, which is the coefficient of thermal expansion of the reel hub 45 (the glass fiber-including polycarbonate), so internal stress that accompanies tension in the circumferential direction occurs at the interface of the circular cylinder wall 46 with the reinforcement ring 68.

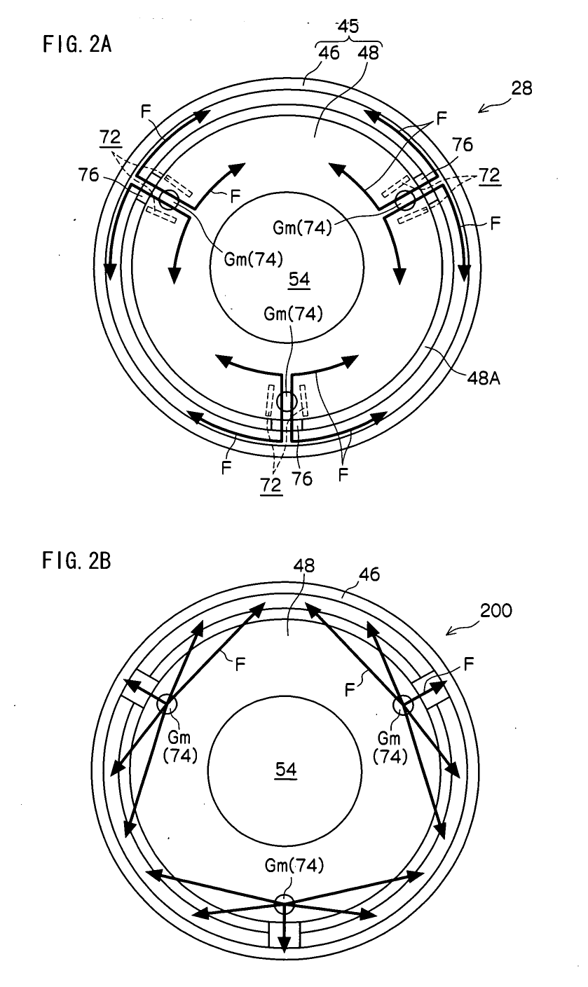

Here, the reel 28 has a configuration where the convex portions 76 with respect to the gate marks Gm of the reel hub 45 are formed and where the groove portions 72 are formed on both circumferential direction sides of the gate marks Gm, so inside the cavity resulting from the molding-use dies 80 and 82, the cross-sectional area of the flow path leading from the gates Gt outward in the radial direction is enlarged in the thickness direction by the convex portions 76, and the cross-sectional area of the flow path leading from the gates Gt in the circumferential direction is narrowed in the thickness direction by the groove portions 72. For this reason, in the present reel 28, as indicated by arrows F in FIG. 2A, at the time of injection molding of the reel hub 45, the polycarbonate PC flows in the radial direction (both sides) from the gate marks Gm and thereafter flows in the circumferential direction beyond the installation range of the groove portions 72.

Thus, in the reel hub 45, the glass fiber that reinforces the polycarbonate PC that configures the circular cylinder wall 46 is oriented (so as to become long) along the circumferential direction of the circular cylinder wall 46. That is, the circular cylinder wall 46 is effectively reinforced by the glass fiber with respect to tension in the circumferential direction. For this reason, in the circular cylinder wall 46 of the reel 28, the occurrence of cracks resulting from control of contraction at the time of molding by the reinforcement ring 68 and running parallel to each other in the circumferential direction (along the radial direction) is effectively controlled.

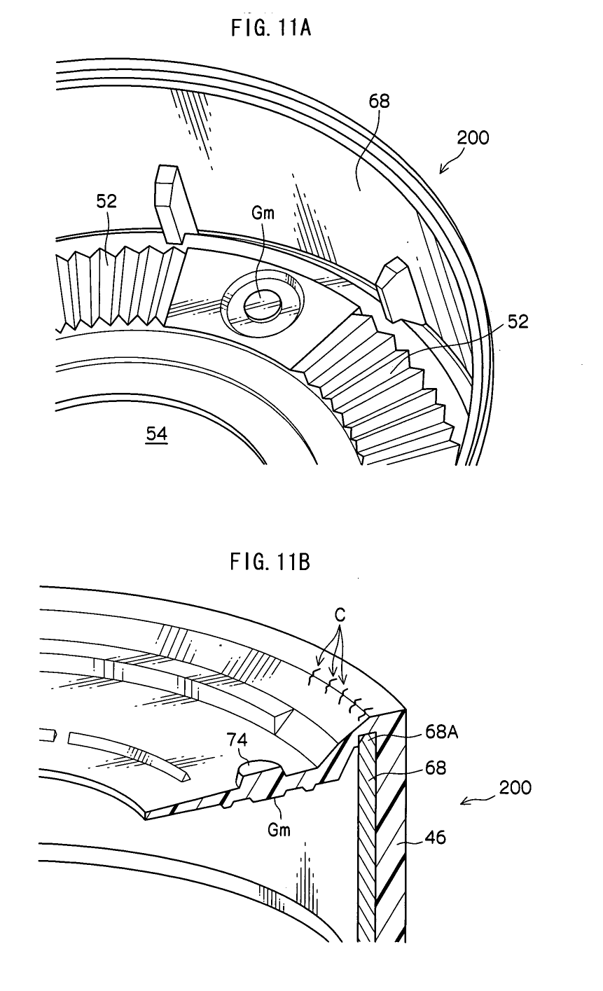

For example, as shown in FIG. 11A and FIG. 11B, in a reel hub 200 pertaining to a comparative example that does not include the convex portions 76 and the groove portions 72, at the time of injection molding, the polycarbonate PC flows radially from the gates Gt of the resin material as shown in FIG. 2B. For this reason, in the vicinities of the gate marks Gm, the effect of reinforcement in the circumferential direction resulting from the glass fiber is small because the glass fiber is oriented along the radial direction of the circular cylinder wall 46. For this reason, in the reel hub 200 pertaining to the comparative example, internal stress that accompanies the above-described tension in the circumferential direction occurs and, as shown in FIG. 11B, it is easy for cracks C running parallel to each other in the circumferential direction to form in the end surface of the circular cylinder wall 46 in the vicinity of the gate marks Gm.

In contrast, in the reel 28, because of the structure where the convex portions 76 and the groove portions 72 are formed as described above, the resin that has flowed in the radial direction selectively in the bottom plate 48 flows in the circumferential direction in the circular cylinder wall 46, whereby the glass fiber is oriented so as to resist the tension in the circumferential direction of the circular cylinder wall 46, so the occurrence (development) of cracks C is controlled. Thus, in the reel 28, dimensional deformation of the tape take-up surface 46A that accompanies the occurrence and development of cracks C and insufficient strength of the circular cylinder wall 46 are controlled. In other words, yield improves.

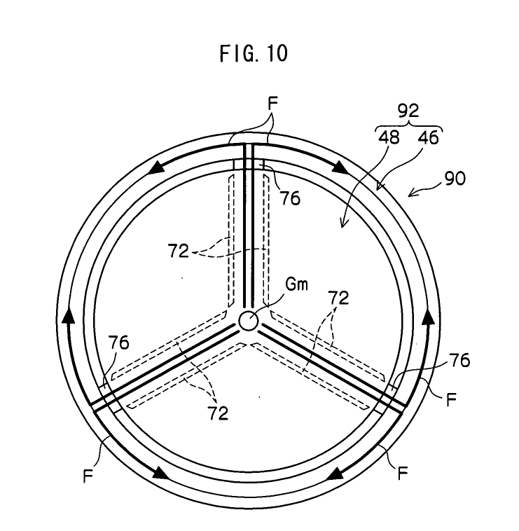

It will be noted that, in the preceding embodiment, an example has been described where the three gate marks Gm were disposed equidistantly in the circumferential direction, but the present invention is not limited to this. For example, as shown in FIG. 10, the present invention may also be applied to a reel 90 where a gate mark Gm is disposed in the axial center portion of the bottom plate 48. In a reel hub 92 of this reel 90, the bottom plate 48 does not include the through hole 54, and a rotation stop and release structure is applied. As this rotation stop and release structure, there can, for example, be employed a structure where a triangular release member, whose three leg portions pressed by the drive gear 106 that meshes with the reel gear 62 project from the site of the bottom plate 48 where the reel gear 62 is formed, is disposed on the bottom plate 48. In this reel 90, the groove portions 72 are formed along the radial direction from the gate mark Gm to the vicinity of the reinforcement ring 68, and the convex portions 76 are formed on the radial direction outer side (the reinforcement ring 68 side) of the gate mark Gm, whereby flows of the polycarbonate PC as indicated by arrows F in FIG. 10 can be generated at the time of injection molding. Consequently, according also to the reel hub 92 of the reel 90 pertaining to this modification, in the vicinity of the gate mark Gm in the circular cylinder wall 46, the glass fiber is oriented in the circumferential direction of the circular cylinder wall 46 and the occurrence of cracks C is controlled.

Further, in the preceding embodiment, an example has been described where the reel 28 included both the groove portions 72 and the convex portions 76, but the present invention is not limited to this, and it suffices for the reel 28 to include at least one of the groove portions 72 and the convex portions 76. Further, the guide structure marks in the present invention are not limited to the groove portions 72 and the convex portions 76 and can employ any type of structure and shape.

Moreover, in the preceding embodiment, an example has been described where the gate marks Gm were disposed on the bottom plate 48 and where the upper flange 50 was disposed integrally with the circular cylinder wall 46, but the present invention is not limited to this and can also be applied to various reels where the reinforcement ring 68 is insert-molded to the circular cylinder wall 46. Consequently, for example, the reel may be given a configuration where the lower flange 56 is formed integrally with the circular cylinder wall 46 and where the upper flange 50 is formed separately from the circular cylinder wall 46 or a configuration where the gate marks Gm are formed on the lower flange 56. Further, the gate marks Gm may also be disposed on the undersurface side of the bottom plate 48. Moreover, for example, the present invention can also be applied to a reel with a so-called three-piece structure where the upper flange 50 and the lower flange 56 are separate from the reel hub 45.

Further still, in the preceding embodiment, an example has been described where the reel hub 45 was formed by the polycarbonate PC into which glass fiber was mixed as reinforcement fiber, but the present invention is not limited to this. The reel hub 45 may also be configured by all types of resin material that are capable of being injection-molded instead of polycarbonate, and carbon fiber or mica may also be employed instead of glass fiber as the reinforcement fiber. Further, the circular cylinder wall 46 of the reel hub 45 may also be configured to have a dimension (thickness) different from what has been described in the preceding embodiment.

Further, in the preceding embodiment, an example has been described where the through hole 54, the clutch-use boss portion 64 and the clear hole 66A were formed in the axial center portion of the reel 28, but the present invention is not limited to this, and the axial center portion of the reel 28 may also be closed, for example. Consequently, the rotation stop structure and the rotation stop and release structure of the reel 28 in the recording tape cartridge 10 to which the reel 28 is applied are not limited to the structures of the preceding embodiment.

Moreover, in the preceding embodiment, an example has been described where the thin portions and the thick portions in the present invention are set by the shape of the bottom plate 48, but the present invention is not limited to this. For example, the thin portions and the thick portions may also be set by configuring by an insert body that sets part of the bottom plate 48 in the molding-use dies 80 and 82. Further, holes and slits (portions of thickness 0) that penetrate the bottom plate 48 in its thickness direction on both circumferential direction sides of the gate marks Gm are also included in the marks of the guide structure in the present invention.

1. A reel disposed with a reel hub made of resin whose outer peripheral surface is configured as a take-up surface of an object-to-be-taken-up and a reinforcement ring that is integrated with the reel hub by insert molding, with reinforcement fiber being mixed into the reel hub or a portion made of resin formed integrally with the reel hub, the reel comprising:
marks of gates for injecting, into a die, a resin material that molds the reel hub; and
at least one of thick portions that are positioned on the reinforcement ring side with respect to the marks of the gates and thin portions that are positioned on both sides, in a circumferential direction of the reel hub, with respect to the marks of the gates.

2. The reel of claim 1, wherein the gate marks are disposed on a radial direction inner side, with respect to the reinforcement ring, of a bottom plate of the reel hub.

3. The reel of claim 1, wherein the thin portions include grooves that are formed along a radial direction on both circumferential direction sides of the gate marks, and outer end portions of the grooves are close to the reinforcement ring.

4. The reel of claim 1, wherein the thick portions are convex portions that are formed between the reinforcement ring and sites that correspond to the gate marks and are on a surface of the bottom plate on the opposite side of the side where the gate marks are formed.

5. A recording tape cartridge comprising:
a case; and
a reel disposed with a reel hub made of resin whose outer peripheral surface is configured as a take-up surface of an object to-be-taken-up and a reinforcement ring that is integrated with the reel hub by insert molding, with reinforcement fiber being mixed into the reel hub or a portion made of resin formed integrally with the reel hub, the reel comprising:
marks of gates for injecting, into a die, a resin material that molds the reel hub; and
at least one of thick portions that are positioned on the reinforcement ring side with respect to the marks of the gates and thin portions that are positioned on both sides, in a circumferential direction of the reel hub, with respect to the marks of the gates,
wherein recording tape is wound around the take-up surface of the reel hub and the reel is housed in the case such that the recording tape is capable of being pulled out and taken up.

6. A reel disposed with a reel hub made of resin whose outer peripheral surface is configured as a take-up surface of an object-to-be-taken-up and a reinforcement ring that is integrated with the reel hub by insert molding, with reinforcement fiber being mixed into the reel hub or a portion made of resin formed integrally with the reel hub, the reel comprising:
a mark of gates for injecting, into a die, a resin material that molds the reel hub; and
marks of a guide structure that is disposed between the marks of the gates and the reinforcement ring and is for guiding the flow of the resin from the gates toward the reinforcement ring at the time of molding of the reel hub.

7. The reel of claim 6, wherein the marks of the guide structure include at least one of thick portions that are positioned on the reinforcement ring side with respect to the marks of the gates and thin portions that are positioned on both sides, in a circumferential direction of the reel hub, with respect to the marks of the gates.

8. The reel of claim 6, wherein the gate marks are disposed on a radial direction inner side, with respect to the reinforcement ring, of a bottom plate of the reel hub.

9. The reel of claim 6, wherein the marks of the guide structure include thin portions that are positioned on both sides, in a circumferential direction of the reel hub, with respect to the marks of the gates, the thin portions include grooves that are formed along a radial direction on both circumferential direction sides of the gate marks, and outer end portions of the grooves are close to the reinforcement ring.

10. The reel of claim 6, wherein the thick portions are convex portions that are formed between the reinforcement ring and sites that correspond to the gate marks and are on a surface of the bottom plate on the opposite side of the side where the gate marks are formed.

11. A recording tape cartridge comprising:
a case; and
a reel disposed with a reel hub made of resin whose outer peripheral surface is configured as a take-up surface of an object-to-be-taken-up and a reinforcement ring that is integrated with the reel hub by insert molding, with reinforcement fiber being mixed into the reel hub or a portion made of resin formed integrally with the reel hub, the reel comprising:
a mark of gates for injecting, into a die, a resin material that molds the reel hub; and
marks of a guide structure that is disposed between the marks of the gates and the reinforcement ring and is for guiding the flow of the resin from the gates toward the reinforcement ring at the time of molding of the reel hub,
wherein recording tape is wound around the take-up surface of the reel hub and the reel is housed in the case such that the recording tape is capable of being pulled out and taken up.
